(19) United States
(12) Patent Application Publication
(10) Pub. No.: US 2008/0241371 A1
(43) Pub. Date: Oct. 2, 2008

(54) Temporary, Water-Proof, Clear or Tinted System, Method of Use and Removal

(75) Inventors: Kathleen O. Havelka, Mentor, OH (US); William P. Taylor, Mentor, OH (US); Carlos A. Piedrahita, Mentor, OH (US); Constance F. Williams, Cleveland Heights, OH (US); Robert N. Sole, Willoughby, OH (US); Gilbert R. Malone, Perry, OH (US); Okson Yi, Chagrin Falls, OH (US)

Correspondence Address: THE LUBRIZOL CORPORATION;ATTN: DOCKET CLERK, PATENT DEPT., 29400 LAKELAND BLVD., WICKLIFFE, OH, 44092, US

(73) Assignee: THE LUBRIZOL CORPORATION, Wickliffe, OH (US)

(21) Appl. No.: 10/597,477

(22) PCT Filed: Jan. 27, 2005
(86) PCT No.: PCT/US05/03051

§ 371 Date: Jan. 16, 2007

Related U.S. Application Data
(60) Provisional application No. 60/540,026, filed on Jan. 29, 2004.

(51) Int. Cl. C09D 5/00; C09B 67/00

(52) U.S. Cl. 427/154; 524/502

(57) ABSTRACT

A highly water resistant coating is described for use as a temporary protective or tinting finish for a wide variety of personal items, including one's vehicle and tires. The film forming polymer of the coating is desirable as it can be applied with polar solvents but then upon evaporation of a solubilizing additive becomes water resistant or water proof. Thereafter if a similar solubilizing additive is used in a polar solvent, the coating can be removed without damaging the surface of the substrate.

### FIELD OF THE INVENTION

The present invention relates to a water-proof composition for temporarily protecting and/or tinting surfaces and methods of using and removing the temporary coating or tint from the surfaces. More specifically, the invention relates to a water-proof composition for temporarily coating surfaces such as glass, metals, ceramics and fiberglass as well as polymeric substrates such as rubber, engineered plastics, vinyl, paint, plastics, plant material, flowers, fabric, artificial turf, athletic playing surfaces, and leather and methods of using and removing the temporary coating without damaging the substrate surface.

### BACKGROUND OF THE INVENTION

Increasingly, consumers are spending money on appearance products for their vehicles. This is especially true for products that enable personalization and differentiation of vehicles. Consumers often wish to modify the surface color of accessories used on or inside their vehicle to either coordinate or contrast that accessory with other parts of their vehicle or to accentuate that color. Examples of accessories that consumers may wish to modify in color to coordinate or contrast with other parts of their vehicle or to accentuate the accessory include, but are not limited to, polymeric substrates such as rubber, engineered plastic, plastic accessories and vinyl accessories, metal accessories, glass accessories, fiberglass accessories and painted accessories.

Although consumers may wish to alter the surface color of the accessories used on or inside their vehicles to coordinate or contrast that color with other parts of their vehicle or to accentuate that color, often times consumers only desire to make the color change on a temporary, nonpermanent basis. However, existing removable commercial surface tinting products are too temporary in nature as they are not resistant to water such as rain, snow and other weather phenomena or simply standing water or puddles. Further, these existing commercial surface tinting products are formulated to give only one accent color while consumers may often wish to have a color change, multi-color or metallic accent. Examples of such coatings include those described in U.S. Pat. No. 6,489,393; US 2002/0156181 A1 and US 2003/0114562. Accordingly, a need exists for a tinting composition which consumers can safely handle and apply to accessories on or inside their vehicles or other surfaces not necessarily associated with vehicles, to temporarily impart a color change effect with multiple colors of their choice to the surface of the accessory while resulting in a water and weather-proof temporary finish that can be removed when the consumer chooses with a simple method.

Tire dressings or polishes to give shine to the tires on a vehicle are a growth area in the automotive appearance products market. Many current commercial products have a number of drawbacks. First, these products are not durably water resistant. Although they give a nice shine to the tire sidewalls in good weather, the first rain shower or puddle causes the product to wear off. Second, because of the nature of these products, they don't fully dry on the tire surface. As soon as the vehicle begins to travel, centrifugal force causes excess product to be thrown off the sidewall onto the car finish where it can cause staining and other damage to the finish. This process is called sling off. Third, because of the nature of these products, they don't fully dry on the tire surface. The tacky residue permits dirt, grime and road debris to adhere to the tire/vehicle surface.

### SUMMARY OF THE INVENTION

The present invention is a temporary yet water proof, optionally color changing tint composition (coating). Color changing tints change color as a function of various factors such as viewing angle and/or external stimuli such as, but not limited to, light, temperature or electrical voltage. The coating is easily and simply removed when desired using aqueous and/or polar organic solvents and a small amount of an optional additive to promote solubility of the film forming resin. The ability to apply and remove the coating without etching or damaging the substrate is an important feature of this disclosure. Another important feature is the combination of that property with a very water resistant (nearly permanently waterproof) nature of the coating. These features are achieved by selecting appropriate solvent(s) in combination with an appropriate film forming polymer and optional additives. In some cases a mild polar solvent such as isopropanol with an isopropanol soluble film forming polymer (but water insoluble polymer) works. In other cases ammonium hydroxide or a volatile amine solubilizes the film forming polymer in water or a mild polar solvent but the film forming polymer is waterproof in the absence of the ammonia hydroxide or amine. In one embodiment the composition, suitable for temporarily tinting a surface, comprises the following components: pigment, a solvent, a water-proof film forming polymer and optionally other additives. The composition may be applied to a variety of surfaces including painted surfaces. Further, the present invention provides a method for using and removing said composition. The method of use involves applying the tint composition by spraying, wiping, sponging, dabbing, rolling and brushing the tint composition onto the surface.

The method of removal often involves applying a remover composition, containing an optional additive, to promote solubility of the film forming polymer, to the tinted surface. Said removal composition comprising a polar solvent mixture and optionally an amine such as, but not limited to, ammonia and/or surfactant or cleaning agents. Optionally, it may contain a rheology modifier to help cling to the surface and promote removability.

In another embodiment the coating is a clear coating such as a tire dressing that provides protection and gloss to a substrate. In this embodiment it forms a water proof film thus lending durability and water repellency to the product though it can be removed as desired with a mildly basic remover. The coating varies from the prior art in that it fully dries onto the surface resulting in no sling off action when applied to tires. Sling off can lead to damaged finish on a vehicle.

### DETAILED DESCRIPTION OF THE INVENTION

Various preferred features and embodiments will be described below by way of non-limiting illustration. Embodiments of the invention provide a new water proof, optionally color changing or metallic tinting composition that is capable of temporarily protecting and/or tinting a surface, for example, the exterior of an automobile. The water proof, optionally color changing or metallic tinting composition comprises a solvent, a water proof film forming polymer, and optionally a pigment(s). The pigment may be a single pigment or a combination of two or more pigments. Other optional additives may also be used. In some embodiments, the composition includes water; in other embodiments, the composition is substantially free of water. Although preferred uses of the protective and/or tinting composition are directed to vehicles and vehicle accessories, other surfaces can be protected and/or tinted. Examples of suitable surfaces which can be protected and/or tinted by the protective and/or tinting composition include, but are not limited to, metal, glass, ceramics, fiberglass, painted surfaces, and plastic surfaces, polymeric substrates such as rubber, engineered plastics, plant material, flowers, fabric, artificial turf, athletic playing surfaces, and leather and vinyl.

Examples of polymeric substrates such as rubber and vinyl accessories on vehicles that consumers may wish to protect and/or modify in color include, but are not limited to, tires, dashboards, bumpers, seats, steering wheels, and mud flaps. Engineered plastic accessories on vehicles that consumers may wish to protect and/or modify in color include, but are not limited to, bumpers, body panels, trim, and consoles. Metal accessories on vehicles that consumers may wish to protect and/or modify in color include, but are not limited to, bumpers, rims, grills and hitches. Also, glass accessories on vehicles that consumers may wish to modify in color include, but are not limited to, windshields and mirrors. Certain fiberglass accessories on vehicles that consumers may wish to protect and/or modify in color include, but are not limited to, body panels. Painted accessories on vehicles that consumers may wish to protect and/or modify in color include, but are not limited to, exterior vehicle paint. Certain plastic accessories on vehicles that consumers may wish to protect and/or modify in color include, but are not limited to, bumpers, headlights, and mirror casings. Additionally consumers may wish to protect and/or modify in color non-vehicular items such as, but not limited to, bicycle/motorcycle helmets, radio controlled cars and skateboards, ceramics and artificial turf.

In some embodiments, the solvents are selected from the group consisting of branched or straight chained aliphatic hydrocarbons, synthetic hydrocarbons, alcohols, water, organic solvents, silicone fluids, paraffinic solvents, volatile solvents, and mixtures thereof. Highly preferred solvents include aqueous solutions or polar solvents such as isopropanol, isobutanol, or t-butanol. Small amounts of strong solvents such as acetone and methyl ethyl ketone may be included in the coating without damaging substrates, if these solvents tend to evaporate before the other solvents (thus they are less likely to damage the substrate). Desirably at least 70, 80 or 90 weight percent of the organic solvents have a water solubility of at least 10 g/100 g of water at 25 C (this assures they are a polar solvent or used in small amounts) and the organic solvent or blends of organic solvents (i.e. excluding water) used have a solubility of less than 10 g/100 g of mineral oil at 25 C (so we exclude acetone and methyl ethyl ketone as the only solvent but permit them in blends with things like isopropanol).

The selection of the solvent(s) for use in the water proof, color changing tinting or metallic composition depends on a variety of factors such as the desired drying time of the tinting composition, the flowability of the tinting composition, the desired degree of dispersing of the pigment in the tinting composition, and environmental considerations. Generally, the solvent(s) is present in the tinting composition in an amount from about 1 to about 99 wt. % of the tinting composition. In certain embodiments, the solvent(s) is present in an amount from about 60 to about 99 wt. % of the tinting composition. In certain other embodiments, the solvent(s) is present in an amount from about 75 to about 97 wt. % of the tinting composition. The solvent(s) need to be selected so that the film forming polymer(s) are applicable to the substrate as a liquid in the solvent but then these film forming polymer(s) dry to a waterproof coating. While waterproof, the film forming polymer(s) need to be removable from the substrate with solvent(s), (optionally with an additive to enhance the solubility of the film forming polymer(s) without damaging or etching the substrate (which may be a painted substrate)). This generally implies that the solvent(s) cannot be entirely water and the solvent(s) cannot be so strong as to dissolve common plastic substrates and paints. Isopropanol is an example of an effective solvent in some of the examples. Optionally volatile additives to the solvent(s), such as ammonia or amines, can solubilize the film forming polymer(s) when desirable (e.g. when applying the composition to a substrate or removing the composition from a substrate) but still allow the dried composition as a coating to be relatively waterproof in the absence of ammonia or volatile amines.

Examples of suitable branched or straight chained aliphatic hydrocarbons include, but are not limited to, Shell Sol 71 and Shell Sol 142HT made by Shell Chemical Company, 2251 oil made by Penreco, and Conosol® C145 made by Penreco. Examples of suitable synthetic hydrocarbons include, but are not limited to, synthetic isoparaffinic hydrocarbons such as Isopar® M made by ExxonMobil Chemical Company. Examples of suitable alcohols include, but are not limited to, methanol, ethanol, iso-propanol, propanols, isobutanol and tert-butyl alcohol. Examples of suitable organic solvents include acetone, hexane, toluene, esters, volatile aldehydes, and volatile ketones. Examples of suitable silicone fluids include, but are not limited to, polydimethylsiloxane, functional silicone polymers, silicone resins, volatile silicones, and silanes. Examples of suitable functional silicone polymers include, but are not limited to, silicones containing amine functional groups, fluorinated functional groups, hydroxy terminated functional groups, cyclic functional groups, vinyl functional groups, and ethoxy functional groups. Where silicone fluids are used as the solvent in the tinting composition, the preferred viscosity range is from about 0.65 to about 12,000,000 cst. Silicone fluids are preferably used as only a minor portion of the solvents (<50 weight percent based on total solvents) or they may be used as other functional additives. Examples of suitable paraffinic solvents include, but are not limited to, Isopar® M made by ExxonMobil Chemical Company. Examples of suitable volatile solvents include, but are not limited to, cyclic silicones, acetone, isopropyl alcohol and mineral spirits.

Suitable solvents include, but are not limited to the following compounds: 1,2,6-hexanetriol; 3-hexenol; acetone; alcohol; alcohol denatured; amyl acetate; benzyl alcohol; benzyl benzoate; butoxydiglycol; butoxyethanol; butyl acetate; butylene glycol; butyrolactone; C₁₀₋₁₁ isoparaffin; C₁₀₋₁₃ isoparaffin; C₁₀₋₁₈ triglycerides; C₁₁₋₁₂ isoparaffin; C₁₁₋₁₃ isoparaffin; C₁₂₋₁₄ isoparaffin; C₁₃₋₁₄ isoparaffin; C₁₃₋₁₆ isoparaffin; C₂₀₋₄₀ isoparaffin; C₇₋₈ isoparaffin; C₈₋₉ isoparaffin; C₉₋₁₁ isoparaffin; C₉₋₁₃ isoparaffin; C₉₋₁₄ isoparaffin; cyclomethicone; deodorized kerosene; diacetin; diacetone alcohol; dibutyl phthalate; diethoxyethyl succinate; diethyl phthalate; diethylene glycol; dimethoxydiglycol; dimethyl ether; dimethyl isosorbide; dimethyl phthalate; dimethyl sulfone; dipentene; diphenyl methane; dipropylene glycol; ethoxydiglycol; ethoxydiglycol acetate; ethoxyethanol; ethoxyethanol acetate; ethyl acetate; ethyl hexanediol; ethylene carbonate; glycofurol; glycol; heptane; hexane; hexyl alcohol; hexyldecanol; hexylene glycol; isoamyl acetate; isobutoxypropanol; isobutyl acetate; isohexadecane; isopentane; isopropyl acetate; isopropyl alcohol; isopropyl myristate; isopropyl palmitate; methoxydiglycol; methoxyethanol; methoxyisopropanol; methoxymethylbutanol; methyl acetate; methyl alcohol; methyl hexyl ether; methylpropanediol; mineral spirits; mixed terpenes; n-butyl alcohol; octyldodecanol; PEG/PPG-1.7/6 copolymer; PEG/PPG-18/4 copolymer; PEG/PPG-23/50 copolymer; PEG/PPG-296/57 copolymer; PEG-10; PEG-12; PEG-135; PEG-14; PEG-150; PEG-16; PEG-18; PEG-20; PEG-200; PEG-32; PEG-350; PEG-4; PEG-40; PEG-6; PEG-6 methyl ether; PEG-75; PEG-8; PEG-9; PEG-90; pentane; petroleum distillates; phenoxyisopropanol; phenylpropanol; PPG-2 methyl ether; PPG-3 methyl ether; propyl acetate; propyl alcohol; propylene carbonate; propylene glycol; t-butyl alcohol; terpineol; tetrahydrofurfuryl acetate; tetrahydrofurfuryl alcohol; thiolanediol; toluene; triacetin; tributyl citrate; tributylcresylbutane; tricaprin; triethyl citrate; triethylene glycol; trihydroxystearin; triisononanoin; triisostearin; trilaurin; trilinolein; trimethylhexanol; trioctanoin; triolein; triundecanoin; turpentine; and xylene. Solvents may also include various hydroxyl terminated, ether capped, or acetate capped glycols, polyglycols, and polyethers.

In some embodiments, the solvent used in the tinting composition is a mixture of isopropyl alcohol and water. In certain embodiments, the solvent used in the tinting composition is a mixture of straight and branched chain hydrocarbons and a polydimethylsiloxane. In some embodiments, the solvent used in the tinting composition is a mixture of straight and branched chain hydrocarbons and a mixture of polydimethylsiloxanes. In certain embodiments, the solvent used in the tinting composition is a mixture of straight and branched chain hydrocarbons and a mixture of polydimethylsiloxanes having varying viscosities. In other embodiments, the solvent used in the tinting composition is a straight chain hydrocarbon, a branched chain hydrocarbon, or a polydimethylsiloxane.

Embodiments of the invention also provide a new method of protecting, applying a high gloss surface, or tinting a surface. The method includes selecting a surface for protecting, glossing or tinting, mixing a solvent, a water proof film forming polymer, optional pigment and optionally other additives to form a tinting composition, and applying the composition to the surface and optionally includes the step of drying the composition.

When applied to the surface, the water proof (to avoid confusion water proof is used here to mean a composition such that desirably more than 8, more desirably more than 24, preferably more than 48, or most preferably more than 72 hours of constant exposure to rain or condensing humidity is required to remove from the coating from a substrate surface), composition is liquid in form. By the term in liquid form we really mean that the film forming polymer is either dissolved or colloidally suspended in the solvent. The water proof, composition can be applied in various manners to the surface. It is contemplated that the water proof composition may be applied to the surface by spraying the water proof, composition onto the surface with a spray trigger or an aerosol can; by sponging, dabbing, brushing, rolling, or wiping the composition onto the surface with a cloth, brush, sponge, pen, marker, roller or similar application means; or by any other suitable means for applying the composition to the surface. Once the composition has been applied to the surface, the tinting composition dries and imparts a color and sheen to the surface. The drying time depends upon the length of time required for the solvent in the composition to evaporate and is affected by the ventilation and the ambient conditions such as the humidity level and the temperature. The drying time can vary from about 10 minutes to about an hour depending on the ambient conditions and the solvent selected. The drying can be accomplished by allowing the composition to be exposed to the ambient conditions or by applying heat to the composition.

Once the composition has been applied to the surface, the composition will remain on the surface for days to weeks. The composition is designed to be temporary, but will remain on the surface and not get washed away by rain, snow and other weather phenomena or simply standing water or puddles that may splash onto the tinted surface. The length of time that the tinting composition remains on the surface depends upon a variety of conditions such as the ambient and environmental conditions, the amount of composition which has been applied to the surface, and the amount of abrasion to which the composition is subjected. When the consumer desires to remove the composition from the tinted surface, one can use a remover system (the method of removal often involves applying a remover composition, containing an optional additive, to promote solubility of the film forming polymer, to the tinted surface). Said removal composition comprising a polar solvent mixture and optionally an amine such as, but not limited to, ammonia and/or surfactant or cleaning agents. Optionally, it may contain a rheology modifier to help cling to the surface and promote removability, and optionally a sponge, cloth, brush, or similar mechanical action to remove the tinting composition. The water proof, color changing or metallic tinting composition will need to be reapplied to the surface should the consumer wish to subsequently impart a tint to the surface.

As mentioned above, the composition includes at least one water proof film forming polymer. Blends of two or more film forming polymers can include both polymers that alone would make waterproof and/or water soluble coatings, so long as the final coating meets the definition of water proof coating. Any water proof film forming polymers may be used in embodiments of the invention that are capable of a) being dissolved or colloidally suspended in the solvent(s), b) thereafter drying to a resilient generally water proof coating and c) subsequently by the addition of a good solvent for the film forming polymer or water or mild polar solvents with an appropriate additive, becoming soluble or colloidally dispersible in water or mild polar solvents. An example of polymers of this type are coacrylate polymers (including two or more different monomers) having acid functionality such that the addition of ammonia, amine, alkanolamine, or counter ions from Group IA or IIA of the periodic table can convert the polymers from a water insoluble or ionically crosslinked polymer to a polymer soluble in water or mildly polar solvents such as isopropanol.

Generally, the water proof film forming polymer is present in the clear or tinting composition in an amount from about 1 to about 50 wt. % of the clear or tinting composition. In certain embodiments, the water proof film forming polymer is present in an amount from about 1 to about 40 wt. % of the clear or tinting composition. In certain other embodiments, the water proof film forming polymer is present in an amount from about 3 to about 25 wt. % of the composition. Suitable water proof film forming polymers include, but are not limited to the following compounds: acrylamide/sodium acrylate copolymer; acrylamides/acrylates/DMAPA/methoxy PEG methacrylate copolymer; acrylamides copolymer; acrylamidopropyltrimonium chloride/acrylates copolymer; acrylates/acetoacetoxyethyl methacrylate copolymer; acrylates/acrylamide copolymer; acrylates/ammonium methacrylate copolymer; acrylates/C₁₀₋₃₀ alkyl acrylate crosspolymer; acrylates/PVP copolymer; acrylates/diacetoneacrylamide copolymer; acrylates/octylacrylamide copolymer; acrylate/styrene copolymer; acrylates/steareth-50 acrylate copolymer; acrylates/VA copolymer; acrylates/VA crosspolymer; acrylates copolymer; acrylic acid/acrylonitrogens copolymer; adipic acid/diethylene glycol/glycerin crosspolymer; adipic acid/diethylenetriamine copolymer; adipic acid/dimethylaminohydroxypropyl diethylenetriamine copolymer; adipic acid/epoxypropyl diethylenetriamine copolymer; adipic acid/isophthalic acid/neopentyl glycol/trimethylolpropane copolymer; allyl stearate/VA copolymer; aminoethylacrylate phosphate/acrylates copolymer; ammonium acrylates/acrylonitrogens copolymer; ammonium acrylates/styrene copolymer; ammonium acrylates copolymer; ammonium VA/acrylates copolymer; AMP-acrylates/diacetoneacrylamide copolymer; AMP-acrylates copolymer; AMPD-acrylates/diacetoneacrylamide copolymer; benzoic acid/phthalic anhydride/pentaerythritol/neopentyl glycol/palmitic acid copolymer; butadiene/acrylonitrile copolymer; butyl benzoic acid/phthalic anhydride/trimethylolethane copolymer; butyl ester of ethylene/MA copolymer; butyl ester of PVM/MA copolymer; butylated PVP; calcium/sodium PVM/MA copolymer; carboxymethyl hydroxyethylcellulose; cellulose gum; cetyl hydroxyethylcellulose; corn starch/acrylamide/sodium acrylate copolymer; dilinoleic acid/ethylenediamine copolymer; dimethicone/mercaptopropyl methicone copolymer; dimethicone/sodium PG-propyldimethicone thiosulfate copolymer; DMAPA acrylates/acrylic acid/acrylonitrogens copolymer; dodecanedioic acid/cetearyl alcohol/glycol copolymer; ethyl ester of PVM/MA copolymer; ethylcellulose; ethylene/acrylic acid/VA copolymer; ethylene/acrylic acid copolymer; ethylene/calcium acrylate copolymer; ethylene/MA copolymer; ethylene/VA copolymer; hydrogenated styrene/methyl styrene/indene copolymer; hydroxybutyl methylcellulose; isobutylene/sodium maleate copolymer; isopropyl ester of PVM/MA copolymer; lanolin cera; lauryl acrylate/VA copolymer; methacryloyl ethyl betaine/acrylates copolymer; methyl methacrylate crosspolymer; octyl acrylamide/acrylates/butylaminoethyl methacrylate copolymer; PEG-8/SMDI copolymer; PEG-crosspolymer; phthalic anhydride/adipic acid/castor oil/neopentyl glycol/PEG-3/trimethylolpropane copolymer; phthalic anhydride/benzoic acid/trimethylolpropane copolymer; phthalic anhydride/butyl benzoic acid/propylene glycol copolymer; phthalic anhydride/glycerin/glycidyl decanoate copolymer; phthalic anhydride/trimellitic anhydride/glycols copolymer; polyacrylamide; polyacrylamidomethylpropane sulfonic acid; polyacrylic acid; polybutylene terephthalate; polydimethylaminoethyl methacrylate; polyglucuronic acid; polyglycerylmethacrylate; polymethacrylamidopropyltrimonium chloride; poly(methyl acrylate); poly(methyl methacrylate); polyoxyisobutylene/methylene urea copolymer; polystyrene; polyurethane; polyvinyl acetate; polyvinyl alcohol; polyvinyl butyral; polyvinyl imidazolinium acetate; polyvinyl laurate; polyvinyl methyl ether; potassium carrageenan; potassium hyaluronate; PPG-26/TDI copolymer; PPG-51/SMDI copolymer; procollagen; PVM/MA copolymer; PVP/VA copolymer; PVP; PVP/decene copolymer; PVP/dimethyl aminoethylmethacrylate copolymer; PVP/eicosene copolymer; PVP/hexadecene copolymer; PVP/VA/itaconic acid copolymer; PVP/VA/vinyl propionate copolymer; PVP/VA copolymer; sodium acrylate/vinyl alcohol copolymer; sodium DVB/acrylates copolymer; sodium polyacrylate starch; sodium polymethacrylate; sodium polystyrene sulfonate; sodium PVM/MA/decadiene crosspolymer; sodium styrene/acrylamide copolymer; sodium styrene/acrylates copolymer; sodium tauride acrylates/acrylic acid/acrylonitrile copolymer; starch/acrylates/acrylamide copolymer; steareth-10 allyl ether/acrylates copolymer; stearylvinyl ether/MA copolymer; styrene/acrylates/acrylonitrile copolymer; styrene/acrylates/ammonium methacrylate copolymer; styrene/allyl benzoate copolymer; styrene/MA copolymer; styrene/PVP copolymer; sucrose benzoate/sucrose acetate isobutyrate/butyl benzyl phthalate/methyl methacrylate copolymer; sucrose benzoate/sucrose acetate isobutyrate/butyl benzyl phthalate copolymer; sucrose benzoate/sucrose acetate isobutyrate copolymer; TEA-acrylates/acrylonitrogens copolymer; tricontanyl PVP; trimethylpentanediol/isophthalic acid/trimellitic anhydride copolymer; tromethamine acrylates/acrylonitrogens copolymer; VA/butyl maleate/isobornyl acrylate copolymer; VA/crotonates/methacryloxybenzophenone-1 copolymer; VA/crotonates/vinyl neodecanoate copolymer; VA/crotonates/vinyl propionate copolymer; VA/crotonates copolymer; VA/DBM copolymer; VA/isobutyl maleate/vinyl neodecanoate copolymer; VA/vinyl butyl benzoate/crotonates copolymer; vinyl acetate; and vinyl caprolactam/PVP/dimethylaminoethyl methacrylate copolymer.

Vinyl resins used in the tinting compositions are derived from monomers containing a carbon to carbon double bond. These monomers polymerize by linear addition to form long chain molecules. Generally, the polymeric resins have the structure:

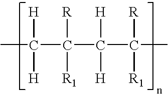

where R and R₁ represent various pendant groups such as, but not limited to, hydrogen, chlorine, acetate, benzene and toluene. The vinyl resins are commonly derived from the monomers vinyl chloride, vinylidene chloride, vinyl acetate, the vinyl acetals, styrene, acrylonitrile and mixtures thereof. The vinyl polymers and copolymers range from about 100 to 10,000 carbon atoms in chain length and can be formed by bulk, solvent, suspension or emulsion polymerization.

Copolymers derived from mixtures of any of the aforedescribed vinyl monomers either with themselves or with other commonly used polymerizable monomers are used herein. Such copolymers possess a wide range of properties and can be formulated to fit individual needs. In another embodiment the film forming polymer(s) can include polyvalent ions such as zinc and/or aluminum as potential ionic crosslinkers of carboxylic acid groups on polymer(s). When zinc and/or aluminum ions are used in such an application they can add further water resistance to a dried coating. The ionic crosslinks from the polyvalent ions can be disrupted by adding a monovalent counterion such as ammonia or amines to displace the polyvalent ions when it is desirable to make the film forming polymer more soluble or dispersible in the solvent.

Useful acrylic resins are the polymerized ester derivatives of acrylic acid, methacrylic acid or other hydrocarbyl acrylic acid. The resins contain the unit below where R₂ can be hydrogen, methyl or other hydrocarbyl group. R can be hydrogen or a hydrocarbyl group of 1 to 20 carbon atoms, more desirable 1 to 10 carbon atoms (such as a linear or branched alkyl or aromatic).

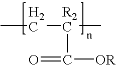

The esters are formed by the reaction of acrylic, methacrylic or other hydrocarbyl acrylic acid with suitable alcohols, e.g., methyl alcohol, ethyl alcohol, propyl alcohol, butyl alcohol and 2-ethylhexyl alcohol. Generally speaking, the larger the alcohol portion of the ester, the softer and more flexible the resultant resin. Also, generally speaking, the methacrylate esters form harder films than the corresponding acrylate esters. Monomers such as styrene, vinyl toluene, vinyl chloride and vinylidine chloride may be reacted with the acrylic and methacrylic esters so as to produce resins with excellent properties.

Thermosetting acrylic resins are normally low molecular weight copolymers made from 2, 3 or more monomers. One of the monomers is an acrylic compound containing pendant reactive groups such as carboxyl, hydroxyl or amide. Another is an acrylic ester. The third monomer is usually a styrene type monomer such as styrene itself, vinyl toluene, methyl styrene or ethyl styrene. The proportions of the three components in the polymerization procedure are varied depending on the products in which the copolymer will be used. One particularly useful film forming polymer is a polymer containing acrylic ester monomers, styrene type monomer and acrylic or methacrylic acid, said acid being neutralized by an amine represented by:

R₁R₂R₃N

where R₁, R₂ and R₃ are independently hydrogen or hydrocarbyl groups of 1 to 10, more desirably 1 to 4 carbon atoms. A preferred hydrocarbyl group for any of R₁, R₂, and/or R₃ would be hydroxyl containing alkyl groups, which would make the formula above be an alkanolamine group. Alternatively the amine could be an ethoxylated amine where ethylene oxide repeat units are added to an alkanol amine.

A preferred polymer of such type would be a polymer of the following monomer composition:

| | |
|---|---|
| Methyl Methacrylate | 5-40 percent weight |
| Ethyl Acrylate | 20-85 percent weight |
| Styrene | 5-40 percent weight |
| Methacrylic Acid | 5-35 percent weight |

with the acid being neutralized with alkanolamines or amines such as triethanol amine, diethylethanol amine, dimethylethanol amine, ammonia. A most preferred example of the preferred polymer would be the film forming polymer Doresco ACW8-6 produced by the Dock Resins Corp. in Linden, N.J., now merged into The Lubrizol Corporation in Wickliffe, Ohio.

The pigment is selected from, but not limited to, the group consisting of iron oxide, bismuth oxychloride, titanium dioxide, mica, calcium sodium borosilicate, organic constituent containing pigments, inorganic constituent containing pigments, fluorescent constituent containing pigments, phosphorescent constituent containing pigments, light interference pigments, luminescent constituent containing pigments, ultraviolet absorbing pigments, mineral constituent containing pigments, amorphous glass oxides, polyacrylates, metal flakes, reflective pigments, or mixtures thereof. Said pigment changing color as a function of external viewing angle, and/or external stimuli such as, but not limited to, light, temperature or electrical voltage.

Suitable pigments for use in preparing the tinting composition include, but are not limited to, iron oxide, bismuth oxychloride, titanium dioxide, mica, calcium sodium borosilicate, organic constituent containing pigments, inorganic constituent containing pigments, fluorescent constituent containing pigments, phosphorescent constituent containing pigments, light interference pigments, luminescent constituent containing pigments, ultraviolet absorbing pigments, mineral constituent containing pigments, amorphous glass oxides, polyacrylates, metal flakes, reflective pigments, and mixtures thereof. The selection of the pigment also varies based upon the color choice and intensity of color one wishes to be able to impart onto the surface. In certain embodiments, the pigment is an inorganic constituent containing pigment. A preferred pigment is mica coated with titanium dioxide or iron oxide such as Mearlin® Hi-Lite Sparkle Green, Mearlin® Hi-Lite Sparkle Blue, Mearlin® Hi-Lite Sparkle Gold, Mearlin® Hi-Lite Sparkle Red, Mearlin® Sparkle Russet, Exterior Mearlin® Sparkle, Mearlin® Sparkle Brass, Mearlin® Sparkle Bronze, Mearlin® Sparkle Copper, Mearlin® Hi-Lite Super Green, Mearlin® Hi-Lite Super Blue, Mearlin® Hi-Lite Super Red, Mearlin® Plum, Mearlin® Kiwi Green, Mearlin® Adobe Green, Mearlin® Firemist Red, and Mearlin® Firemist Blue made by Engelhard Corporation, Microlith Yellow made by Ciba Specialty Chemicals, and Helicone® HC made by Wacker. Additional useful pigments are available from EMD Chemicals Inc., which is owned by Merck. These include but are not limited to Colorstream® pigments, multi-color effect pigments such as: Colorstream® F20-00 WNT Autumn Mystery and Colorstream® T20-01 WNT Viola Fantasy (exterior grades). Additional useful pigments are available from BASF. These include but are not limited to Variocrom® pigments, Color Variable Pigments™ that are multilayered interference pigments with a core consisting of platelike aluminum or iron (III) oxide with angle dependent color change such as: Magic Gold K 1411, Magic Green K 9811, Magic Red K 4411 (multiple coated aluminum flake), Magic Purple K 5511 (multiple coated micaceous iron oxide), Magic Purple L 5520 (iron oxide pigment, coated with silicon oxide and iron oxide), Magic Gold L 1400, and Magic Red L 4420 (aluminum pigment coated with silicon oxide and iron oxide). Regular pigments like carbon blacks, phthalocyanine blues and greens, yellow and red iron oxides, and other organic and inorganic pigments may be used. Additional pigments include, but are not limited to, pigments sold by Engelhard Corporation such as the Mearlin® Magnapearls & White Pearlescents, the Mearlin® White Pearlescents, the Mearlin®. Hi-Lite Interference Colors, the Mearlin® Dynacolor Luster Pigments, the Mearlin® “Non-Metallic” Metallic Colors, the Mearlin® Santa Fe Colors, the Mearlin® Micro Pearls, the Mearlin® Sparkle Colors, the Mearlite® Industrial Grades, the Mearlin® Firemist pigments, and the Mearlin® Vegetable Colors. A most preferred pigment is a light interference or color shifting pigment which is, in one embodiment, an aluminum core surrounded with multi thin film layers such as the ChromaFlair® pigments sold by Flex Products Inc.

Generally, the pigment, when present, is present in the tinting composition in an amount from about 0.001 to about 50 wt. % of the tinting composition. In certain embodiments, the pigment is present in an amount from about 0.1 to about 25 wt. % of the tinting composition. In certain other embodiments, the pigment is present in an amount from about 0.1 to about 15 wt. % of the tinting composition.

In some embodiments the composition contains no pigment and comprises solvent, one or more solvents may be present, a water-proof, film-forming polymer and optionally other film forming polymers or other additives. In these embodiments it can be a clear coating, possibly adding gloss and/or protection only to the substrate. These other additives are one or more of the following components: rheology modifiers, corrosion inhibitors, thickeners, surface tension reducers, silica, emulsifiers, fragrance, release agents, wetting agents, ultraviolet additives, and other additives to add or enhance the desired properties of the composition. A preferred use for a composition from this embodiment is as a dressing or polish for vehicle tires.

A preferred composition from this embodiment of a clear coating such as for tires has the following formula:

| | |
|---|---|
| Non-ionic surfactant | 2-10 percent by weight |
| SiliconeFluid | 2-20 percent by weight |
| Film-forming acrylic polymer | 1-25 percent by weight |
| Glycerol | 0-5% |
| Fragrance | 0-5 percent by weight |
| Water | 10-90 percent by weight |

A preferred composition from this embodiment of this embodiment of a clear coating such as for tires that is free of silicone oils has the following formula:

| | |
|---|---|
| Film-forming acrylic polymer | 20-45 percent by weight |
| Water | 10-80 percent by weight |
| Glycerol | 0-5 percent by weight |
| Anionic surfactant | 2-15 percent by weight |
| Alcohol | 10-30 percent by weight |
| Solvent | 2-20 percent by weight |

In addition to a solvent, film forming polymer and optional pigment, the composition may further include one or more of the following components: rheology modifiers, corrosion inhibitors, thickeners, surface tension reducers, silica, emulsifiers, fragrance, release agents, wetting agents, ultraviolet additives, and other additives to add or enhance the desired properties of the tinting composition. The use of these optional components and the desired amounts of each component is based upon the desired properties of the composition such as the degree of coloration and the viscosity of the composition; the shelf life of the composition; the desired scent of the composition; and the means used to apply the composition to the surface.

In some embodiments, silica is added to the composition to aid in suspending the pigment within the composition. The silica that is selected for use in the composition can be used either alone or in combination in varying proportions with other silica. Examples of suitable silica which can be used in the present invention include, but are not limited to, fumed silica such as Aerosil® R202 made by Degussa and CAB-O-SIL® TS720 made by Cabot Corporation, precipitated silica such as Zeothix 265 made by J. M. Huber Corporation, and mixtures thereof although other silica may also be used. A preferred silica used in embodiments of the invention is fumed silica. Generally, silica is present in the tinting composition in an amount from about 0.001 to about 30 wt. % of the tinting composition. In certain embodiments, the silica is present in an amount from about 0.01 to about 15 wt. % of the tinting composition. In certain other embodiments, the silica is present in an amount from about 0.1 to about 10 wt. % of the tinting composition.

In some other embodiments, an emulsifier is added to the tinting composition to aid in keeping the components of the tinting composition in solution, to thicken the suspension of the tinting composition, and to serve as a dispersant for the pigment. It is desired to use an emulsifier in the tinting composition where the solvent is water in order to thicken the suspension of the tinting composition. Suitable emulsifiers include, but are not limited to, nonionic, cationic, anionic and amphoteric surfactants, block polymers, block copolymers, acrylics, primary and secondary emulsifiers, and mixtures thereof although other emulsifiers may also be used. The emulsifier that is selected for use in the tinting composition can be used either alone or in combination in varying proportions with other emulsifiers. Generally, an emulsifier is present in the tinting composition in an amount from about 0.001 to about 20 wt. % of the tinting composition. In certain embodiments, the emulsifier is present in an amount from about 0.1 to about 15 wt. % of the tinting composition. In certain other embodiments, the emulsifier is present in an amount from about 0.5 to about 10 wt. % of the tinting composition.

Any emulsifying agent or emulsifier may be used in embodiments of the invention. Suitable emulsifying agents include, but are not limited to the following compounds identified by the INCI names: 7-dehydrocholesterol; abietic acid; acetylated glycol stearate; avocadamide DEA; bentonite; beta-sitosterol; C₁₂₋₁₃ alcohols; C₁₂₋₁₅ alcohols; C₁₂₋₁₆ alcohols; C₁₅₋₁₈ glycol; C₂₂₋₂₄ pareth-33; C₉₋₁₁ alcohols; calcium carrageenan; Carbomer; carboxymethyl hydroxyethylcellulose; carboxymethyl hydroxypropyl guar; carrageenan; cellulose gum; cera microcristallina; ceresin; cetearyl alcohol; cocamide; cocamide DEA; cocamide MEA; cocamide MIPA; cocamidopropyl lauryl ether; dihydroxyethyl cocamine oxide; ethylene/acrylic acid copolymer; ethylene/VA copolymer; glycol cetearate; hydrogenated C₁₂₋₁₈ triglycerides; hydrogenated lanolin alcohol; hydrogenated tallow amide; hydroxybutyl methylcellulose; hydroxyethyl ethylcellulose; hydroxyethylcellulose; hydroxypropyl guar; hydroxypropyl methylcellulose; hydroxypropylcellulose; isopropyl ester of PVM/MA copolymer; lanolinamide DEA; lauryl alcohol; maltodextrin; methoxy PEG-22/dodecyl glycol copolymer; methylcellulose; microcrystalline cellulose; montmorillonite; myristyl alcohol; oxyquinoline sulfate; ozokerite; palm kernelamide DEA; palm kernelamide MEA; palm kernelamide MIPA; palmamide DEA; palmamide MEA; palmamide MIPA; peanutamide MEA; peanutamide MIPA; pectin; PEG-115m; PEG-14m; PEG-20m; PEG-23m; PEG-2m; PEG-45/dodecyl glycol copolymer; PEG-5m; PEG-7m; PEG-90m; PEG-9m; pentadecyl alcohol; polyacrylic acid; polyvinyl acetate; potassium alginate; potassium carrageenan; PVM/MA copolymer; PVP; PVP/dimethylaminoethylmethacrylate copolymer; PVP/VA copolymer; saccharated lime; scleroglucan; sclerotium gum; sodium acrylate/vinyl alcohol copolymer; sodium C₄₋₁₂ olefin/maleic acid copolymer; sodium carboxymethyl dextran; sodium carrageenan; sodium cellulose sulfate; sodium polymethacrylate; sodium polynaphthalenesulfonate; sodium polystyrene sulfonate; soyamide DEA; stearic acid; stearyl alcohol; styrene/MA copolymer; synthetic beeswax; synthetic candelilla wax; synthetic carnauba; synthetic japan wax; synthetic wax; tallow amide; tallowamide DEA; tallowamide MEA; tetrasodium etidronate; tridecyl alcohol; and xanthan gum.

In some embodiments, a fragrance is added to provide a scent to the clear or tinting composition. Any fragrance known in the art which imparts the desired scent to the composition can be used. The fragrance that is selected for use in the composition can be used either alone or in combination in varying proportions with other fragrances. Generally, a fragrance is present in the composition in an amount from about 0.0001 to about 15 wt. % of the composition. In certain embodiments, the fragrance is present in an amount from about 0.01 to about 5 wt. % of the composition.

In some other embodiments, an additive to reduce the effect of ultraviolet light on the coating is added to protect the tinting composition from sunlight. Examples of suitable such additives include, but are not limited to, free radical scavengers, antioxidants, hindered amines, antistatic agents, and mixtures thereof although other ultraviolet additives may also be used. The additive to reduce the effect of ultraviolet light that is selected for use in the tinting composition can be used either alone or in combination in varying proportions with other additives. Generally, an additive to reduce the effect of ultraviolet light when present in the tinting composition is used in an amount from about 0.001 to about 10 wt % of the tinting composition. In certain embodiments, said additive is present in an amount from about 0.01 to about 5 wt % of the composition.

As described above, a number of ingredients or components may be present in the clear tinting composition in accordance with embodiments of the invention. The following table shows the weight percentages for each component. It should be recognized that these ranges are merely preferences and that not all listed components need to be present in the clear or tinting composition. A composition falling outside the preferred ranges is still within the scope of the invention described and claimed herein. The weight percentages are based on the total weight of the clear or tinting composition. It should be recognized that the ingredients or components of the tinting composition can be added in any order to prepare the composition.

TABLE 1

| | | | Most |
|---|---|---|---|
| | | Preferred | Preferred |
| | Range | Range | Range |
| Component | (wt %) | (wt %) | (wt %) |
| Solvent | 1-99 | 60-99 | 75-97 |
| Pigment | 0.001-50 | 0.1-25 | 0.1-15 |
| Film Forming | 1-50 | 1-40 | 3-25 |
| Polymer | | | |
| Rheology Additive | 0.001-30 | 0.01-15 | 0.1-10 |
| Surfactant | 0.001-20 | 0.1-15 | 0.5-10 |
| Fragrance | 0.0001-15 | 0.001-10 | 0.01-5 |
| Ultraviolet Additive | 0.001-15 | 0.001-10 | 0.01-5 |

### EXAMPLES

The following examples are presented to illustrate various embodiments of the invention. All numerical values are approximate numbers. The specific details in each example should not be construed to limit the invention as otherwise described and claimed herein. The following examples show various tinting compositions made in accordance with embodiments of the invention. The amount of each component added to each tinting composition is provided in weight percent of the total composition.

### Example 1

A jar was charged with 178 grams of isopropyl alcohol. Added 20 grams of a film forming polymer, Doresco® ACW8-6 from Dock Resins, to the alcohol and stirred to disperse/dissolve the resin. Once the resin was dissolved, added 2 grams of pigment, Variocrom® Magic Gold from BASF, and stirred to mix in the pigment. The above tinting composition was sprayed onto ACT painted metal test panels with an industry standard spray gun using 50-60 psi of air. As an alternative, the above mixture was charged to a standard aerosol spray can and the can pressurized with CO₂ propellant to about 60 psi. This composition was also sprayed onto ACT painted metal test panels. Spraying created a tint on the panel that showed different colors based on the viewing angle.

### Example X

A jar was charged with 178 grams of isopropyl alcohol. Added 20 grams of a film forming polymer, Doresco® ACW8-6 from Dock Resins, to the alcohol and stirred to disperse/dissolve the resin. Once the resin was dissolved, added 2 grams of pigment (Variocrom® Magic Gold from BASF or Helicone® Maple HC from Wacker-Chemie), and stirred to mix in the pigment. The admixture was charged to standard aerosol spray cans and the cans pressurized with various mixtures of volatile hydrocarbons that included propane, n-butane, isobutane and dimethyl ether (DME). These compositions were sprayed onto APR43997, black automotive quality panels ACT Laboratories, Inc.

The removability of the tint from the ACT panel was determined after 7 days of exposure to UV, heat and moisture in the QUV Weatherometer tester. Once the 7 days of QUV test is completed, the temporary tint was removed using a glass cleaner type of formulation. In order to make sure the removal of the tint does not affect the quality of the original coating, the gloss readings of the uncoated panels were measured. The ACT panels were cut into 4″×6″ sections and all but a vertical area of about 1.5″-2″ width running the length of the panel was masked off using making tape. The tint in the spray can was sprayed 3 passes, and the making tape was removed next-day. These coated panels along with blank (uncoated panel) were then exposed a cycle of UV light at 70° C. and condensing humidity at 50° C. for 7 days. The QUV testing conditions (QFS 40 UV lamps, black panel temperature light cycle at 70° C. for 8 hours and condensation cycle at 50° C. for 4 hours without light) were established based on SAE International Surface Vehicle Standard: SAE J2020 Rev. February 2003.

At the end of the 7 days QUV test, the tint remained on the panel with no change. Using the glass cleaner type of formulation, the tint could be easily removed by spraying onto the tinted surface then using a cloth or paper towel to remove the tint. After the temporary tint was removed from the panel, the gloss readings were re-taken. As shown in the below table, the changes in the gloss readings are very slight or none. These measurements show that the painted surface was unaffected by the tint and the method of removal.

| | Blank | | |
|---|---|---|---|
| | (uncoated | Gold Tint | Maple Tint |
| Gloss Reading | panel) | Coated Panel | Coated Panel |
| Initial 20° Gloss | 89.8 | 89.7 | 89.8 |
| Final 20° Gloss | 88.1 | 88.5 | 87.8 |
| Initial 60° Gloss | 93.9 | 93.8 | 93.8 |
| Final 60° Gloss | 93.9 | 93.8 | 93.0 |

Initial gloss: gloss reading of the panel before the QUV test
Final gloss: gloss reading of the panel after the 7 days QUV test, and removal of the tint

### Example 2

A jar was charged with 178 grams of isopropyl alcohol. Added 20 grams of a film forming polymer, Doresco® ACW8-6 from Dock Resins, to the alcohol and stirred to disperse/dissolve the resin. Once the resin was dissolved, added 2 grams of pigment, ChromaFlair® Cyan/Purple 230 from Flex Products, and stirred to mix in the pigment. The above tinting composition was sprayed onto ACT painted metal test panels with an industry standard spray gun using 50-60 psi of air. Spraying created a tint on the panel that showed different colors based on the viewing angle. The panel was placed in a QUV tester from Q-Panel Corp. for 1 week exposed to condensing humidity and ultraviolet light. At the end of this week the tint remained on the panel with no change. The tint could not be removed by scrubbing with a soap solution. Using a glass cleaner type of formulation the tint could be removed by spraying onto the tinted surface then using a cloth or paper towel to remove the tint. The painted surface was unaffected by the tint and the method of removal.

### Example 3

The temporary, color change tint for this test was prepared in the following manner:

A ½ pint lined can was charged with 20 grams Doresco ACW8-6 and 178 grams of isopropyl alcohol. Mixed for ten minutes then added 1 gram of pigment and mixed for another five minutes. (The pigments used in this work were ChromaFlair pigments from Flex Products.) Black automotive quality panels from ACT Laboratories, Inc. (APR25032) were cut into 4″×6″ sections and all but a vertical area of about 1.5″-2″ width running the length of the panel was masked off using tape. The temporary, color change tint was then sprayed on the panels using two passes with a standard industry spray gun. The panels were allowed to dry for 5-10 minutes before the masking tape was removed.

The water resistance of the temporary, color change tint as sprayed on the panels was tested using a QUV Weatherometer tester. The panels were exposed to UV light at 70° C. and condensing humidity at 50° C. The QUV testing conditions were established based on SAE international Surface Vehicle Standard: SAE J2020 Rev. February 2003. The critical test parameters were: QFS-40 UV lamps, Black Panel Temperature Light Cycle 70+/−3° C. and Condensation cycle 50° C. no light. The Cycle timer was programmed to give the following test conditions except when stopped to inspect the test panels: 8 hours UV light at 70° C. alternating with 4 hours of condensation exposure and no light at 50° C.

Panels were inspected after 48 hours of continuous exposure then after one week of continuous exposure and measurements taken of color, gloss and haze. Though there was change in the measured color, gloss and haze, visual inspection of the panel showed that the temporary, color change tint was not washed away by the water on exposure to repeated condensation. Further, when exposed to running water under a faucet, at the end of test, the tint remained in place.

### Example 4

A jar was charged with 5 grams of Doresco® ACW8-6 resin, 74.875 grams of water, 2.5 grams Triton® X-100, 2.5 grams of Triton® X-45, 0.125 grams limonene, and 15 grams of Dow Corning 200® Fluid, 100 cSt. The mixture was gently shaken to form a milky emulsion. This mixture was then transferred to a trigger spray bottle. The mixture was sprayed onto tires as a mist and allowed to dry without wiping. The mixture dried to produce a transparent, glossy durable film on the tire.

### Example 5

A jar was charged with 35 grams of Doresco® ACW8-6 resin, 25 grams of water, 13.5 grams propyl propasol, 10 grams of butyl cellosolve, 10 grams sodium xylene sulfonate, 5 grams isopropyl alcohol, and 1.5 grams of glycerol. The mixture was gently agitated to form a slightly hazy solution. The mixture was applied onto tires and allowed to dry. The mixture dried to produce a transparent, glossy durable film on the tire.

As used herein, the term “hydrocarbyl substituent” or “hydrocarbyl group” is used in its ordinary sense, which is well-known to those skilled in the art. Specifically, it refers to a group having a carbon atom directly attached to the remainder of the molecule and having predominantly hydrocarbon character. Examples of hydrocarbyl groups include:

(1) hydrocarbon substituents, that is, aliphatic (e.g., alkyl or alkenyl), alicyclic (e.g., cycloalkyl, cycloalkenyl) substituents, and aromatic-, aliphatic-, and alicyclic-substituted aromatic substituents, as well as cyclic substituents wherein the ring is completed through another portion of the molecule (e.g., two substituents together form a ring);

(2) substituted hydrocarbon substituents, that is, substituents containing non-hydrocarbon groups which, in the context of this invention, do not alter the predominantly hydrocarbon substituent (e.g., halo (especially chloro and fluoro), hydroxy, alkoxy, mercapto, alkylmercapto, nitro, nitroso, and sulfoxy);

(3) hetero substituents, that is, substituents which, while having a predominantly hydrocarbon character, in the context of this invention, contain other than carbon in a ring or chain otherwise composed of carbon atoms. Heteroatoms include sulfur, oxygen, nitrogen, and encompass substituents as pyridyl, furyl, thienyl and imidazolyl. In general, no more than two, preferably no more than one, non-hydrocarbon substituent will be present for every ten carbon atoms in the hydrocarbyl group; typically, there will be no non-hydrocarbon substituents in the hydrocarbyl group.

It is known that some of the materials described above may interact in the final formulation, so that the components of the final formulation may be different from those that are initially added. For instance, metal ions can migrate to other acidic sites of other molecules. The products formed thereby, including the products formed upon employing the composition of the present invention in its intended use, may not susceptible of easy description. Nevertheless, all such modifications and reaction products are included within the scope of the present invention; the present invention encompasses the composition prepared by admixing the components described above.

Each of the documents referred to above is incorporated herein by reference. Except in the Examples, or where otherwise explicitly indicated, all numerical quantities in this description specifying amounts of materials, reaction conditions, molecular weights, number of carbon atoms, and the like, are to be understood as modified by the word “about.” Unless otherwise indicated, each chemical or composition referred to herein should be interpreted as being a commercial grade material which may contain the isomers, byproducts, derivatives, and other such materials which are normally understood to be present in the commercial grade. However, the amount of each chemical component is presented exclusive of any solvent or diluent oil which may be customarily present in the commercial material, unless otherwise indicated. It is to be understood that the upper and lower amount, range, and ratio limits set forth herein may be independently combined. As used herein, the expression “consisting essentially of” permits the inclusion of substances which do not materially affect the basic and novel characteristics of the composition under consideration.

What is claimed is:

1. A tinting composition for tinting a surface comprising: a solvent(s) in the amount from about 55 to about 99 wt %; a film forming polymer in the amount from about 0 to about 50 wt %; pigment in the amount from about 0.001 to about 50 wt %, and optionally other additives such as rheology modifiers, thickeners, ultraviolet additives, corrosion inhibitors, emulsifiers and mixtures thereof, wherein said film forming polymer is characterized by its ability to form a waterproof film while capable of being selectively removed after drying without etching the underlying substrate by dissolving in an appropriate polar solvent or solubilizing with an additive in polar solvent promoting solubilization of said film forming polymer by forming a salt with said polymer.

2. The tinting composition of claim 1, wherein at least one of the film forming polymers comprises from about 5 to about 40 weight percent of repeating units from methyl methacrylate, from about 20 to about 85 weight percent of repeating units from ethyl acrylate, from about 5 to about 40 weight percent of repeating units from styrene, and from about 5 to about 35 weight percent of repeating units from methacrylic acid.

3. The tinting composition of claim 1, wherein the film forming polymer is soluble to the extent of 1 gram per 100 grams of isopropanol at 25 C or to the extent of 1 gram per 100 grams of a 3 wt. % ammonia water at 25 C.

4. The tinting composition of claim 1, wherein the surface is a polymeric substrate.

5. The tinting composition of claim 4, wherein the polymeric substrate is selected from the group consisting of rubber, engineered plastic, and vinyl.

6. The tinting composition of claim 4, wherein the polymeric substrate is selected from the group consisting of the surface of a tire, dashboard, bumper, steering wheel, mud-flap, and seat.

7. The tinting composition of claim 4, wherein the polymeric substrate is selected from the group consisting of the surface of a bicycle helmet, motorcycle helmet and ski boots.

8. The tinting composition of claim 1, wherein the surface is selected from the group consisting of metal, glass, fiberglass, plastic, and paint.

9. The tinting composition of claim 1, wherein the solvent consists essentially of water and/or organic solvent(s) at least 80 wt. % of said solvent(s) being characterized by an individual solubility of at least 10 g/100 g of water at 25° C. and a blend of all non-water solvents in said solvent(s) having a solubility of less than 10 g/100 g of mineral oil at 25° C.

10. The tinting composition of claim 9 wherein the solvent comprises isopropyl alcohol as at least 25 weight percent of the total solvent.

11. The tinting composition of claim 1, wherein the pigment is an inorganic constituent containing pigment.

12. The tinting composition of claim 1, wherein the pigment is selected from the group consisting of aluminum coated with magnesium fluoride and chromium.

13. The tinting composition of claim 1, further comprising an emulsifier.

14. The tinting composition of claim 13, wherein the emulsifier comprises from about 0.001 to about 20 wt. % of the tinting composition.

15. The tinting composition of claim 1, further comprising an additive to reduce deleterious effects of ultraviolet light on the coating.

16. The tinting composition of claim 1, wherein the pigment comprises from about 0.1 to about 50 wt. % of the tinting composition.

17. The tinting composition of claim 1, wherein the pigment is selected from the group consisting of mica coated with titanium dioxide and mica coated with iron oxide.

18. A tinting composition for tinting a surface comprising: water or organic solvent(s) or blends thereof, at least 80 wt. % of said solvent(s) having solubility of at least 10 g/100 g of water at 25° C. and said solvent(s) as a blend having solubility less than 10 g/100 g of mineral oil at 25° C.; an acrylate ester/acrylate salt/styrene terpolymer; pigment; and optionally other additives such as rheology modifiers, thickeners, ultraviolet additives, corrosion inhibitors, emulsifiers and mixtures thereof.

19. The tinting composition of claim 18, wherein the surface comprises a polymeric substrate or polymeric coated substrate.

20. The tinting composition of claim 19, wherein the polymeric substrate or polymeric coated substrate is selected from the group consisting of rubber, engineered plastic, and vinyl.

21. The tinting composition of claim 19, wherein the surface is selected from the group consisting of the surface of a tire, dashboard, bumper, steering wheel, mudflap, and seat.

22. The tinting composition of claim 18, wherein the surface is selected from the group consisting of metal, glass, fiberglass, painted substrate, and plastic.

23. The tinting composition of claim 18, wherein the solvent is a mixture of water and organic solvents.

24. A method of tinting a surface comprising: selecting a surface for tinting; mixing a solvent(s) in the amount from about 75 to about 99.9 wt %, a film forming polymer in the amount from about 3 to about 25 wt %, and pigment in the amount from about 0.1 to about 15 wt %; and optionally other additives such as rheology modifiers, thickeners, additives reducing the effects of ultraviolet radiation, corrosion inhibitors, emulsifiers and mixtures thereof to form a tinting composition; and applying the tinting composition to the surface the improvement wherein said film forming polymer is soluble or dispersible in polar solvents that do not appreciably swell or etch a polymeric substrate and said film forming polymer dries to a water resistant coating that can be removed with a slightly basic polar solvent or solvent blend that does not swell or etch a polymeric substrate upon removal of the coating.

25. The method of claim 24, including a step of removing said water resistant coating with a solvent blend that dissolves the film forming polymer or with a slightly basic polar solvent and option some mechanical action that doesn't etch said polymeric substrate.

26. The method of claim 24, wherein the step of applying is accomplished by spraying the tinting composition onto the surface.

27. The method of claim 24, wherein the step of applying is accomplished by one of the steps selected the group consisting of sponging, dabbing, brushing, rolling, and wiping the tinting composition onto the surface.

28. The method of claim 24, wherein the surface is a polymeric substrate.

29. The method of claim 28, wherein the polymeric substrate is selected from the group consisting of rubber, rigid plastic, and flexible vinyl.

30. The method of claim 28, wherein the polymeric substrate is selected from the group consisting of the surface of a tire, dashboard, bumper, steering wheel, mud-flap, and seat.

31. The method of claim 24, wherein the surface is selected from the group consisting of metal, glass, fiberglass, painted surface, and plastic.

32. The method of claim 24, wherein the solvent comprises from about 50 to about 99.9 wt. % and pigment comprises from about 0.1 to about 50 wt. % of the tinting composition.

33. A fast-drying, water-proof composition for applying as a dressing, polish, tint, or protective layer to tires; other rubber, vinyl or leather surfaces; or hard surfaces on vehicles comprising: solvent in the amount from about 55 to about 90 weight percent; at least one water-proof film-forming polymer in the amount from about 1 to about 50 weight percent based on the composition weight and optionally a) glycerin in the amount from about 0.5 to about 15 weight percent; b) surfactant in the amount from about 1 to about 25 weight percent; and c) silicone fluid in the amount from about 10 to about 40 weight percent.

34. The fast-drying, water-proof composition for applying as a dressing, polish, tint, or protective layer of claim 33, wherein said at least one waterproof film-forming polymer comprises from about 5 to about 40 weight percent of repeating units from methyl methacrylate, from about 20 to about 85 weight percent of repeating units from ethyl acrylate, from about 5 to about 40 weight percent of repeating units from styrene, and from about 5 to about 35 weight percent of repeating units from methacrylic acid.

35. The fast-drying, water-proof composition for applying as a dressing, polish, tint, or protective layer of claim 33, wherein said silicone fluid is present in an amount from about 10 to about 40 weight percent and is selected from polydimethylsiloxane, functional silicone polymers, silicone resins, volatile silicones, and silanes.

36. The fast-drying, water-proof composition for applying as a dressing, polish, tint, or protective layer of claim 33, wherein said composition exists as a sprayable dispersion of said water-proof film-forming polymer in a continuous phase comprising at least a portion of said solvents.

37. A method of applying the fast-drying, water-proof composition for applying as a dressing, polish, tint, or protective layer of claim 33, wherein the step of applying is accomplished by spraying, sponging, dabbing, brushing, rolling, and/or wiping the water-proof composition onto a surface.
